(19) United States
(12) Patent Application Publication
(10) Pub. No.: US 2023/0040220 A1
(43) Pub. Date: Feb. 9, 2023

(54) METHOD AND APPARATUS FOR PROCESSING TIME SYNCHRONIZATION PACKET

(71) Applicant: HUAWEI TECHNOLOGIES CO., LTD., Shenzhen (CN)

(72) Inventors: Li QIANG, Beijing (CN); Fang YU, Shenzhen (CN); Yongcui LI, Beijing (CN)

(73) Assignee: HUAWEI TECHNOLOGIES CO., LTD., Shenzhen (CN)

(21) Appl. No.: 17/959,605

(22) Filed: Oct. 4, 2022

Related U.S. Application Data
(63) Continuation of application No. PCT/CN2021/074633, filed on Feb. 1, 2021.

(30) Foreign Application Priority Data
Apr. 9, 2020 (CN) 202010276198.1

(51) Int. Cl. H04W 56/00; H04W 28/02

(52) U.S. Cl. CPC H04W 56/0015; H04W 28/0268; H04J 3/0667

(57) ABSTRACT

A method for processing a time synchronization packet is provided. In an embodiment a terminal device receives a time synchronization packet of a first clock source from an external device; receives first indication information from a network device, where the first indication information instructs the terminal device to enter a time synchronization activated state of the first clock source, or the first indication information instructs the terminal device to enter a time synchronization deactivated state of the first clock source; and processes the time synchronization packet of the first clock source based on the first indication information. When a clock source is activated and deactivated, the terminal device processes a time synchronization packet of the clock source in different manners, and signaling indicates whether the clock source is activated or deactivated.

### CROSS-REFERENCE TO RELATED DISCLOSURES

This application is a continuation of International Application No. PCT/CN2021/074633, filed on Feb. 1, 2021, which claims priority to Chinese Patent Application No. 202010276198.1, filed on Apr. 9, 2020. The disclosures of the aforementioned applications are hereby incorporated by reference in their entireties.

### TECHNICAL FIELD

This disclosure relates to the communications field, and more specifically, to a method and an apparatus for processing a time synchronization packet.

### BACKGROUND

Time synchronization is a basis for implementing communication reliability and accuracy. In the currently known technology, two communication parties perform time synchronization based on a packet (that is, a time synchronization packet) carrying information of a same clock source, for example, a grant master (GM) clock source.

With the development of communications technologies, communications services have become diversified, and different services have different requirements on time synchronization precision. Therefore, in the known technology, a communications device (for example, a terminal device) has a capability of performing time synchronization based on a plurality of clock sources and a plurality of latency sensitive network (TSN) clock sources with different precision, so that different clock sources can be used for synchronization based on different service requirements.

In this case, the communications device needs to maintain a time synchronization packet of each clock source. This increases power consumption of the communications device, and affects performance of the communications device.

### SUMMARY

This disclosure provides a method and an apparatus for processing a time synchronization packet, to reduce power consumption of a communications device, and improve performance of the communications device while ensuring a service requirement on time synchronization precision.

According to a first aspect, a method for processing a time synchronization packet is provided, including: A terminal device receives a time synchronization packet of a first clock source from an external device; receives first indication information from a network device, where the first indication information instructs the terminal device to enter a time synchronization activated state of the first clock source, or the first indication information instructs the terminal device to enter a time synchronization deactivated state of the first clock source; and processes the time synchronization packet of the first clock source based on the first indication information.

The first processing manner is different from the second processing manner. In the first processing manner, the terminal device processes the clock synchronization packet of the first clock source in the time synchronization activated state of the first clock source. In the second processing manner, the terminal device processes the clock synchronization packet of the first clock source in the time synchronization deactivated state of the first clock source.

According to the solution provided in this disclosure, when a clock source is activated and deactivated, the terminal device processes a time synchronization packet of the clock source in different manners, and signaling indicates whether the clock source is activated or deactivated. This can allow the terminal device to perform processing in different manners. For example, in the deactivated state, the terminal device does not need to perform processing that needs to be performed in the activated state. This can reduce power consumption of a communications device, and improve performance of the communications device while ensuring a service requirement on time synchronization precision.

In this disclosure, “the first indication information instructs the terminal device to enter a time synchronization activated (activation) state of the first clock source” may be understood as follows: The first indication information instructs the terminal device to activate the first clock source, the first indication information instructs the terminal device to activate time synchronization for the first clock source, the first indication information instructs the terminal device to enable a time synchronization capability for the first clock source, or the first indication information includes an activation request for the first clock source.

In addition, “the first indication information instructs the terminal device to enter a time synchronization deactivated (deactivation) state” may be understood as follows: The first indication information instructs the terminal device to deactivate the first clock source, the first indication information instructs the terminal device to deactivate time synchronization for the first clock source, the first indication information instructs the terminal device to disable a time synchronization capability for the first clock source, or the first indication information includes a deactivation request for the first clock source.

For example, when the first indication information indicates to enter the activated state, the processing the time synchronization packet of the first clock source based on the first indication information includes: keeping time synchronization of the first clock source based on the first indication information, updating information carried in the time synchronization packet of the first clock source, and forwarding the time synchronization packet of the first clock source to a user plane function UPF entity.

When the first indication information indicates to enter the deactivated state, the processing the time synchronization packet of the first clock source based on the first indication information includes: discarding the time synchronization packet of the first clock source.

When the first indication information indicates to enter the deactivated state, the method further includes: stopping, based on the first indication information, performing time synchronization based on the time synchronization packet of the first clock source.

Alternatively, when the first indication information indicates to enter the deactivated state, the processing the time synchronization packet of the first clock source based on the first indication information includes: transparently transmitting the time synchronization packet of the first clock source.

Herein, the “transparently transmitting” may be understood as that when receiving the time synchronization packet of the first clock source, the terminal device does not update time information carried in the time synchronization packet, but directly sends the time synchronization packet of the first clock source to a next-hop device.

For another example, when the first indication information indicates to enter the activated state, the processing the time synchronization packet of the first clock source based on the first indication information includes: establishing a first quality of service flow (QoS flow) based on the first indication information. The first QoS flow is used for transmitting the time synchronization packet of the first clock source.

When the first indication information indicates to enter the deactivated state, the processing the time synchronization packet of the first clock source based on the first indication information includes: tearing down the first QoS flow based on the first indication information. The first QoS flow is used for transmitting the time synchronization packet of the first clock source.

The term “tearing down” may also be understood as clearing, releasing, or deleting.

In this disclosure, the foregoing processing manner in the activated state or the deactivated state may be specified by a communications system or a communications protocol.

Alternatively, the foregoing processing manner in the activated state or the deactivated state may be set on the terminal device by a device manufacturer or an operator.

Therefore, the foregoing processing manner in the activated state or the deactivated state does not need to be indicated by the network device. This can reduce signaling overheads.

Optionally, when the first indication information indicates to enter the activated state, the first indication information further indicates the first processing manner, and the first processing manner includes at least one of the following processing manners:

Manner a: Update the information carried in the time synchronization packet of the first clock source, and send an updated time synchronization packet of the first clock source to the UPF.

Manner b: Establish the first QoS flow. The first QoS flow is used for transmitting the time synchronization packet of the first clock source.

Optionally, when the first indication information indicates to enter the deactivated state, the first indication information further indicates the second processing manner, and the second processing manner includes at least one of the following processing manners:

Manner c: Transparently transmit the time synchronization packet of the first clock source.

Manner d: Discard the time synchronization packet of the first clock source.

Manner e: Tear down the first QoS flow. The first QoS flow is used for transmitting the time synchronization packet of the first clock source.

In this disclosure, the processing manner in the activated state or the deactivated state may be indicated by the network device. This can reduce storage overheads of the terminal device caused by storing the processing manner.

Optionally, the first indication information includes an identifier of the first clock source.

In this disclosure, the first clock source includes a clock source of an external system.

The external system may be understood as a system other than a communications system on which the terminal device currently resides.

For example, the first clock source includes a latency sensitive network TSN clock source.

It should be understood that the foregoing first clock source is merely an example for description, and this is not particularly limited in this disclosure. A clock source of another system falls within the protection scope of this disclosure.

Optionally, the time synchronization packet of the first clock source includes a generic precision time protocol (gPTP) packet.

Optionally, the time synchronization packet of the first clock source includes a precision time protocol (PTP) packet.

It should be noted that the time synchronization packet may be appropriately changed according to a system to which this disclosure is applied. This is not particularly limited in this disclosure.

Optionally, the first indication information includes an identifier of the terminal device, the identifier of the first clock source, and a first identifier. The first identifier indicates the activated state, or the first identifier indicates the deactivated state.

The first identifier may correspond to a preset field or domain in the first indication information.

In addition, the first identifier (Indication) may include two optional values, for example, on and off. One value (for example, on) corresponds to an activated state, and the other value (for example, off) corresponds to a deactivated state. Therefore, the terminal device may determine to enter the activated state or the deactivated state based on the first identifier.

By way of example, and not limitation, the identifier of the terminal device may include but is not limited to a mobile phone number of the terminal device, a device identifier of the terminal device, an internet protocol address of the terminal device, and the like.

Optionally, the first indication information includes a port number of a first port, and the first port includes a port configured to transmit the time synchronization packet of the first clock source.

By way of example, and not limitation, the first port may include all ports corresponding to the terminal device.

Alternatively, the first port may include a part or all of a plurality of ports configured to transmit the time synchronization packet of the first clock source.

Optionally, the first indication information includes an identifier of a first application service entity. The first application service entity is configured to provide a first service for the terminal device, and the first service is based on time synchronization of the first clock source.

Optionally, if the first indication information indicates to enter the activated state, the method further includes: keeping time synchronization of the first clock source based on the first indication information.

Optionally, if the first indication information indicates to enter the deactivated state, the method further includes: stopping time synchronization of the first clock source based on the first indication information.

According to a second aspect, a method for processing a time synchronization packet is provided, including: A network device generates first indication information, where the first indication information instructs a terminal device to enter a time synchronization activated state of a first clock source, or the first indication information instructs the terminal device to enter a time synchronization deactivated state of the first clock source, and the first clock source includes a clock source of an external system; and sends the first indication information.

The first processing manner is different from the second processing manner. In the first processing manner, the terminal device processes the clock synchronization packet of the first clock source in the time synchronization activated state of the first clock source. In the second processing manner, the terminal device processes the clock synchronization packet of the first clock source in the time synchronization deactivated state of the first clock source.

According to the solution provided in this disclosure, when a clock source is activated and deactivated, the terminal device processes a time synchronization packet of the clock source in different manners, and signaling indicates whether the clock source is activated or deactivated. This can allow the terminal device to perform processing in different manners. For example, in the deactivated state, the terminal device does not need to perform processing that needs to be performed in the activated state. Therefore, this can reduce power consumption of a communications device, and improve performance of the communications device while ensuring a service requirement on time synchronization precision.

Optionally, the first indication information includes an identifier of the terminal device, an identifier of the first clock source, and a first identifier. The first identifier indicates the activated state, or the first identifier indicates the deactivated state.

The first identifier may correspond to a preset field or domain in the first indication information.

In addition, the first identifier (Indication) may include two optional values, for example, on and off. One value (for example, on) corresponds to an activated state, and the other value (for example, off) corresponds to a deactivated state. Therefore, the terminal device may determine to enter the activated state or the deactivated state based on the first identifier.

By way of example, and not limitation, the identifier of the terminal device may include but is not limited to a mobile phone number of the terminal device, a device identifier of the terminal device, an internet protocol address of the terminal device, and the like.

Optionally, the first indication information includes a port number of a first port, and the first port includes a port configured to transmit a time synchronization packet of the first clock source.

By way of example, and not limitation, the first port may include all ports corresponding to the terminal device.

Alternatively, the first port may include a part or all of a plurality of ports configured to transmit the time synchronization packet of the first clock source.

Optionally, the first indication information includes an identifier of a first application service entity. The first application service entity is configured to provide a first service for the terminal device, and the first service is based on time synchronization of the first clock source.

Optionally, when the first indication information indicates to enter the activated state,

the first indication information instructs the terminal device to update information carried in the time synchronization packet of the first clock source, and forward the time synchronization packet of the first clock source to a user plane function UPF entity; or

the first indication information instructs the terminal device to establish a first QoS flow. The first QoS flow is used for transmitting the time synchronization packet of the first clock source.

Optionally, when the first indication information indicates to enter the deactivated state,

the first indication information instructs the terminal device to discard the time synchronization packet of the first clock source;

the first indication information instructs the terminal device to transparently transmit the time synchronization packet of the first clock source; or

the first indication information instructs the terminal device to tear down the first QoS flow. The first QoS flow is used for transmitting the time synchronization packet of the first clock source.

Optionally, the first clock source includes a latency sensitive network TSN clock source.

Optionally, the time synchronization packet of the first clock source includes a gPTP packet.

Optionally, the method further includes: recording the activated state of the first clock source in the terminal device. The activated state includes activation or deactivation.

Optionally, the method further includes: receiving second indication information, where the second indication information requests to activate the first clock source in the terminal device, or the second indication information requests to deactivate the first clock source in the terminal device.

That a network device generates first indication information includes:

generating the first indication information based on the second indication information.

Optionally, the generating the first indication information based on the second indication information includes:

generating the first indication information based on the second indication information and the activated state of the first clock source in the terminal device. The activated state includes activation or deactivation.

For example, if the second indication information requests to activate the first clock source in the terminal device, and the activated state of the first clock source in the terminal device is deactivated, the first indication information is generated. The first indication information instructs the terminal device to enter the time synchronization activated state of the first clock source.

For another example, if the second indication information requests to activate the first clock source in the terminal device, and the second indication information is first information that is received by the network device and that requests to activate synchronization for the first clock source in the terminal device, the first indication information is generated. The first indication information instructs the terminal device to enter the time synchronization activated state of the first clock source.

For another example, if the second indication information requests to deactivate the first clock source in the terminal device, and the activated state of the first clock source in the terminal device is activated, the first indication information is generated. The first indication information instructs the terminal device to enter the time synchronization deactivated state of the first clock source.

For another example, if the second indication information requests to deactivate the first clock source in the terminal device, the activated state of the first clock source in the terminal device is activated, and no AF other than an AF that sends the second indication information provides a service for the terminal device based on the first clock source, the first indication information is generated. The first indication information instructs the terminal device to enter the time synchronization deactivated state of the first clock source.

Optionally, the method further includes: receiving the second indication information, where the second indication information requests to activate time synchronization of the first clock source of the terminal device, or the second indication information requests to deactivate time synchronization of the first clock source of the terminal device; and

processing the first QoS flow based on the second indication information, where the first QoS flow is for the first terminal device to transmit the time synchronization packet of the first clock source.

For example, when the second indication information requests to activate time synchronization of the first clock source of the terminal device, the first QoS flow is established based on the second indication information. The first QoS flow is for the first terminal device to transmit the time synchronization packet of the first clock source.

For another example, when the second indication information requests to deactivate time synchronization of the first clock source of the terminal device, the first QoS flow is torn down based on the second indication information.

Optionally, the processing the first QoS flow based on the second indication information includes: processing the first QoS flow based on the second indication information and a status of the first clock source in the first terminal device.

For example, if the second indication information is first information that is received by the network device and that requests to activate time synchronization of the first clock source of the terminal device, the first QoS flow is established. The first QoS flow is for the first terminal device to transmit the time synchronization packet of the first clock source.

Alternatively, if the second indication information requests to activate time synchronization of the first clock source of the terminal device, and the first clock source in the terminal device is in the deactivated state, the first QoS flow is established.

For another example, if the second indication information requests to deactivate time synchronization of the first clock source of the terminal device, and an application service AF entity that sends the second indication information is a last AF that provides a service for the terminal device based on the first clock source, the first QoS flow is torn down.

Alternatively, if the second indication information requests to deactivate time synchronization of the first clock source of the terminal device, and no AF other than an AF that sends the second indication information provides a service for the terminal device based on the first clock source, the first QoS flow is torn down.

Optionally, that a network device generates first indication information includes: The network device generates the first indication information based on the second indication information.

Optionally, that the network device generates the first indication information based on the second indication information includes: The network device generates the first indication information based on the second indication information and the status of the first clock source in the first terminal device.

Optionally, that the network device generates the first indication information based on the second indication information and the status of the first clock source in the first terminal device includes:

if the second indication information is first information that is received by the network device and that requests to activate time synchronization of the first clock source of the terminal device, generating the first indication information that instructs the terminal device to enter the time synchronization activated state of the first clock source.

Optionally, that the network device generates the first indication information based on the second indication information and the status of the first clock source in the first terminal device includes:

if the second indication information requests to deactivate time synchronization of the first clock source of the terminal device, and the application service AF entity that sends the second indication information is the last AF that provides the service for the terminal device based on the first clock source, generating the first indication information that instructs the terminal device to enter the time synchronization deactivated state of the first clock source.

Optionally, the second indication information includes the identifier of the terminal device, the identifier of the first clock source, and a second identifier. The second identifier indicates the activation, or the second identifier indicates the deactivation.

The second identifier may correspond to a preset field or domain in the second indication information.

In addition, the second identifier (Indication) may include two optional values, for example, on and off. One value (for example, on) corresponds to activation, and the other value (for example, off) corresponds to deactivation. Therefore, the network device may determine to perform activation or deactivation based on the second identifier. Optionally, the second indication information is sent by the first application service entity, and the second indication information includes the identifier of the first application service entity.

Optionally, the network device includes a session management function (SMF) entity.

Optionally, the network device includes a network exposure function (NEF) entity.

Optionally, the network device includes an access management function (AMF) entity.

Optionally, the network device includes a policy control function (PCF) entity.

According to a third aspect, a time synchronization method is provided, including: A terminal device receives first indication information, where first indication information indicates a manner of processing a time synchronization packet for a first clock source; and

processes the time synchronization packet of the first clock source based on the first indication information.

Optionally, the processing manner includes at least one of the following processing manners. Manner a: Update information carried in the time synchronization packet of the first clock source, and send an updated time synchronization packet of the first clock source to a UPF.

Manner b: Establish a first QoS flow. The first QoS flow is used for transmitting the time synchronization packet of the first clock source.

Manner c: Transparently transmit the time synchronization packet of the first clock source.

Manner d: Discard the time synchronization packet of the first clock source.

Manner e: Tear down the first QoS flow. The first QoS flow is used for transmitting the time synchronization packet of the first clock source.

Manner f: Keep time synchronization of the first clock source.

Manner g: Stop time synchronization of the first clock source.

According to the solution provided in this disclosure, a network device configures a manner of processing a time packet of a clock source for the terminal device, so that the manner of processing the time synchronization packet by the terminal device can be flexibly adjusted based on an actual use status. This can reduce power consumption of a communications device, and improve performance of the communications device while ensuring a service requirement on time synchronization precision.

Optionally, the first indication information includes an identifier of the terminal device, an identifier of the first clock source, and a first identifier. The first identifier indicates an activated state, or the first identifier indicates a deactivated state.

The first identifier may correspond to a preset field or domain in the first indication information.

In addition, the first identifier (Indication) may include two optional values, for example, on and off. One value (for example, on) corresponds to an activated state, and the other value (for example, off) corresponds to a deactivated state. Therefore, the terminal device may determine to enter the activated state or the deactivated state based on the first identifier.

By way of example, and not limitation, the identifier of the terminal device may include but is not limited to a mobile phone number of the terminal device, a device identifier of the terminal device, an internet protocol address of the terminal device, and the like.

Optionally, the first indication information includes a port number of a first port, and the first port includes a port configured to transmit the time synchronization packet of the first clock source.

By way of example, and not limitation, the first port may include all ports corresponding to the terminal device.

Alternatively, the first port may include a part or all of a plurality of ports configured to transmit the time synchronization packet of the first clock source.

Optionally, the first indication information includes an identifier of a first application service entity. The first application service entity is configured to provide a first service for the terminal device, and the first service is based on time synchronization of the first clock source.

According to a fourth aspect, a time synchronization method is provided, including: A network device sends first indication information. The first indication information indicates a manner of processing a time synchronization packet for a first clock source GM.

Optionally, the processing manner includes at least one of the following processing manners.

Manner a: Update information carried in the time synchronization packet of the first clock source, and send an updated time synchronization packet of the first clock source to a UPF.

Manner b: Establish a first QoS flow. The first QoS flow is used for transmitting the time synchronization packet of the first clock source.

Manner c: Transparently transmit the time synchronization packet of the first clock source.

Manner d: Discard the time synchronization packet of the first clock source.

Manner e: Tear down the first QoS flow. The first QoS flow is used for transmitting the time synchronization packet of the first clock source.

Manner f: Keep time synchronization of the first clock source.

Manner g: Stop time synchronization of the first clock source.

According to the solution provided in this disclosure, the network device configures a manner of processing a time packet of a clock source for a terminal device, so that the manner of processing the time synchronization packet by the terminal device can be flexibly adjusted based on an actual use status. This can reduce power consumption of a communications device, and improve performance of the communications device while ensuring a service requirement on time synchronization precision.

Optionally, the first indication information includes an identifier of the terminal device, an identifier of the first clock source, and a first identifier. The first identifier indicates an activated state, or the first identifier indicates a deactivated state.

The first identifier may correspond to a preset field or domain in the first indication information.

In addition, the first identifier (Indication) may include two optional values, for example, on and off. One value (for example, on) corresponds to an activated state, and the other value (for example, off) corresponds to a deactivated state. Therefore, the terminal device may determine to enter the activated state or the deactivated state based on the first identifier.

By way of example, and not limitation, the identifier of the terminal device may include but is not limited to a mobile phone number of the terminal device, a device identifier of the terminal device, an internet protocol address of the terminal device, and the like.

Optionally, the first indication information includes a port number of a first port, and the first port includes a port configured to transmit the time synchronization packet of the first clock source.

By way of example, and not limitation, the first port may include all ports corresponding to the terminal device.

Alternatively, the first port may include a part or all of a plurality of ports configured to transmit the time synchronization packet of the first clock source.

Optionally, the first indication information includes an identifier of a first application service entity. The first application service entity is configured to provide a first service for the terminal device, and the first service is based on time synchronization of the first clock source.

Optionally, the method further includes: recording the activated state of the first clock source in the terminal device. The activated state includes activation or deactivation.

Optionally, the method further includes: receiving second indication information, where the second indication information requests to activate the first clock source in the terminal device, or the second indication information requests to deactivate the first clock source in the terminal device.

That the network device generates the first indication information includes:

generating the first indication information based on the second indication information.

Optionally, the generating the first indication information based on the second indication information includes:

generating the first indication information based on the second indication information and the activated state of the first clock source in the terminal device. The activated state includes activation or deactivation.

For example, if the second indication information requests to activate the first clock source in the terminal device, and the activated state of the first clock source in the terminal device is deactivated, the first indication information is generated. The first indication information indicates at least one of the foregoing processing manners a and b.

For another example, if the second indication information requests to deactivate the first clock source in the terminal device, and the activated state of the first clock source in the terminal device is activated, the first indication information is generated. The first indication information indicates at least one of the foregoing processing manners c, d, and e.

For another example, if the second indication information requests to deactivate the first clock source in the terminal device, the activated state of the first clock source in the terminal device is activated, and no disclosure function entity requests to activate the first clock source in the terminal device, the first indication information is generated. The first indication information indicates at least one of the foregoing processing manners c, d, and e.

Optionally, the method further includes: receiving the second indication information. The second indication information requests to activate time synchronization of the first clock source of the terminal device, or the second indication information requests to deactivate time synchronization of the first clock source of the terminal device.

When the second indication information requests to activate time synchronization of the first clock source of the terminal device, the first QoS flow is established based on the second indication information. The first QoS flow is for the first terminal device to transmit the time synchronization packet of the first clock source.

When the second indication information requests to deactivate time synchronization of the first clock source of the terminal device, the first QoS flow is torn down based on the second indication information.

Optionally, the second indication information includes an identifier of the terminal device, an identifier of the first clock source, and a first identifier. The first identifier indicates an activated state, or the first identifier indicates a deactivated state.

The first identifier may correspond to a preset field or domain in the first indication information.

In addition, the first identifier (Indication) may include two optional values, for example, on and off. One value (for example, on) corresponds to an activated state, and the other value (for example, off) corresponds to a deactivated state. Therefore, the terminal device may determine to enter the activated state or the deactivated state based on the first identifier.

Optionally, the second indication information is sent by the first application service entity, and the second indication information includes the identifier of the first application service entity.

Optionally, the network device includes a session management function (SMF) entity.

Optionally, the network device includes a network exposure function (NEF) entity.

Optionally, the network device includes an access management function (AMF) entity.

Optionally, the network device includes a policy control function (PCF) entity.

According to a fifth aspect, an apparatus for processing a time synchronization packet is provided. Units in the apparatus are separately configured to perform steps of the communication method according to the first aspect or the third aspect and any implementation of the first aspect or the third aspect.

In a design, the apparatus is a communication chip. The communication chip may include an input circuit or interface configured to send information or data, and an output circuit or interface configured to receive information or data.

In another design, the apparatus is a communications device, and the communications device may include a transmitting device configured to send information or data, and a receiving device configured to receive information or data.

According to a sixth aspect, an apparatus for processing a time synchronization packet is provided. Units in the apparatus are separately configured to perform steps of the communication method according to the second aspect or the fourth aspect and any implementation of the second aspect or the fourth aspect.

In a design, the apparatus is a communication chip. The communication chip may include an input circuit or interface configured to send information or data, and an output circuit or interface configured to receive information or data.

In another design, the apparatus is a communications device, and the communications device may include a transmitting device configured to send information or data, and a receiving device configured to receive information or data.

According to a seventh aspect, a communications device is provided, including a processor and a memory. The memory is configured to store a computer program, and the processor is configured to invoke the computer program from the memory and run the computer program, so that the communications device performs the communication method according to any one of the first aspect to the fourth aspect and the implementations of the first aspect to the fourth aspect.

Optionally, there are one or more processors, and there are one or more memories.

Optionally, the memory may be integrated with the processor, or the memory and the processor are separately disposed.

Optionally, the terminal device further includes a transmitting device (a transmitter) and a receiving device (a receiver).

According to an eighth aspect, a communications system is provided, including the communications device provided in the ninth aspect.

In a possible design, the communications system may further include another device that interacts with the communications device in the solutions provided in embodiments of this disclosure.

According to a ninth aspect, a communications system is provided, including the foregoing network device and terminal device.

The terminal device is configured to indicate the method according to the implementations of the first aspect or the third aspect, and the network device is configured to perform the method according to the implementations of the second aspect or the fourth aspect.

In a possible design, the communications system may further include another device that interacts with the network device or the terminal device in the solutions provided in embodiments of this disclosure.

According to a tenth aspect, a computer program product is provided. The computer program product includes a computer program (which may also be referred to as code or instructions). When the computer program is run, a computer is enabled to perform the method according to any one of the first aspect to the fourth aspect and the possible implementations of the first aspect to the fourth aspect.

According to an eleventh aspect, a computer-readable medium is provided. The computer-readable medium stores a computer program (which may also be referred to as code or instructions). When the computer program is run on a computer, the computer is enabled to perform the method according to any one of the first aspect to the fourth aspect and the possible implementations of the first aspect to the fourth aspect.

According to a twelfth aspect, a chip system is provided, including a memory and a processor. The memory is configured to store a computer program, and the processor is configured to invoke the computer program from the memory and run the computer program, to enable a communications device on which the chip system is installed performs the method according to any one of the first aspect to the fourth aspect and the possible implementations of the first aspect to the fourth aspect.

The chip system may include an input circuit or interface configured to send information or data, and an output circuit or interface configured to receive information or data.

### BRIEF DESCRIPTION OF DRAWINGS

FIG. 1 is a schematic diagram of an example of a communications system according to this disclosure;

FIG. 2 is a schematic diagram of another example of a communications system according to this disclosure;

FIG. 3 is a schematic interaction diagram of an example of a method for processing a time synchronization packet according to this disclosure;

FIG. 4 is a schematic interaction diagram of another example of a method for processing a time synchronization packet according to this disclosure;

FIG. 5 is a schematic interaction diagram of still another example of a method for processing a time synchronization packet according to this disclosure;

FIG. 6 is a schematic diagram of an example of an apparatus for processing a time synchronization packet according to this disclosure;

FIG. 7 is a schematic diagram of an example of an apparatus for processing a time synchronization packet according to this disclosure; and

FIG. 8 is a schematic diagram of an example of a terminal device according to this disclosure.

### DESCRIPTION OF EMBODIMENTS

The following describes technical solutions of this disclosure with reference to accompanying drawings.

The technical solutions in embodiments of this disclosure may be applied to various communications systems, for example, a long term evolution (LTE) system, an LTE frequency division duplex (FDD) system, an LTE time division duplex (TDD) system, a universal mobile telecommunication system (UMTS) system, a future 5th generation (5G) system, or a new radio (NR) system.

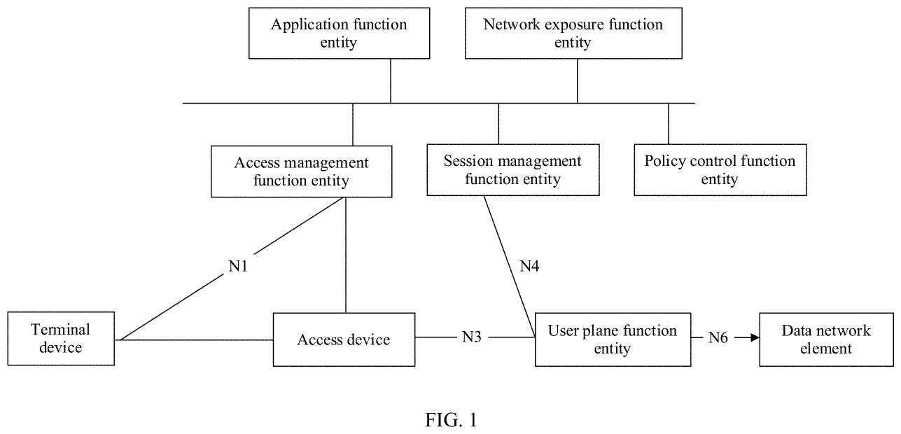

The following describes a structure of a communications system in this disclosure with reference to FIG. 1.

As shown in FIG. 1, the communications system includes but is not limited to the following network elements.

1. Terminal Device

The terminal device in embodiments of this disclosure may also be referred to as user equipment (UE), a mobile station (MS), a mobile terminal (mMT), an access terminal, a subscriber unit, a subscriber station, a mobile station, a remote station, a remote terminal, a mobile device, a user terminal, a terminal, a wireless communications device, a user agent, a user apparatus, or the like.

The terminal device may be a device that provides voice/data connectivity for a user, for example, a handheld device or a vehicle-mounted device that has a wireless connection function. Currently, examples of some terminals are a mobile phone, a tablet computer, a laptop computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, a cellular phone, a cordless telephone set, a session initiation protocol (SIP) phone, a wireless local loop (WLL) station, a personal digital assistant (PDA), a handheld device having a wireless communication function, a computing device or another processing device connected to a wireless modem, a vehicle-mounted device, a wearable device, a terminal device in a future 5G network, a terminal device in a future evolved public land mobile network (PLMN), or the like. This is not limited in the embodiments of this disclosure.

By way of example, and not limitation, in embodiments of this disclosure, the terminal device may alternatively be a wearable device. The wearable device may also be referred to as a wearable intelligent device, and is a general term of a wearable device that is intelligently designed and developed for daily wear by using a wearable technology, for example, glasses, gloves, a watch, clothing, and shoes. The wearable device is a portable device that can be directly worn on the body or integrated into clothes or an accessory of a user. The wearable device is not only a hardware device, but also implements a powerful function through software support, data exchange, and cloud interaction. Generalized wearable intelligent devices include full-featured and large-size devices that can implement complete or partial functions without depending on smartphones, such as smart watches or smart glasses, and devices that focus on only one type of disclosure and need to work with other devices such as smartphones, such as various smart bands or smart jewelry for monitoring physical signs.

In addition, the terminal device in embodiments of this disclosure may alternatively be a terminal device in an internet of things (IoT) system. IoT is an important part of future information technology development. A main technical feature of the IoT is to connect an object to a network by using a communications technology, to implement an intelligent network for human-machine interconnection and thing-thing interconnection.

In embodiments of this disclosure, an IoT technology may implement massive connections, deep coverage, and terminal power saving by using, for example, a narrowband NB technology. For example, the NB may include one resource block (RB). In other words, a bandwidth of the NB is only 180 KB. To implement massive access, terminals need to be discrete in access. According to a communication method in embodiments of this disclosure, a congestion problem that occurs in the IoT technology when massive terminals access a network by using the NB can be effectively resolved.

In addition, in this embodiment of this disclosure, the terminal device may further communicate with a terminal device in another communications system, for example, communication between devices. For example, the terminal device may further transmit (for example, send and/or receive) a time synchronization packet with a terminal device in another communications system.

2. Access Device

In addition, the access device in embodiments of this disclosure may be a device configured to communicate with a terminal device. The access device may also be referred to as an access network device or a radio access network device. For example, the access device may be an evolved NodeB (evolved NodeB, eNB or eNodeB) in an LTE system, a radio controller in a cloud radio access network (CRAN) scenario, a relay station, an access point, a vehicle-mounted device, a wearable device, an access device in a future 5G network, an access device in a future evolved PLMN network, an access point (AP) in a WLAN, a gNB in a new radio system (NR) system. This is not limited in this embodiment of this disclosure.

In addition, in this embodiment of this disclosure, the access device is a device in a RAN, in other words, is a RAN node that connects the terminal device to a wireless network. By way of example and not limitation, the access device may be a gNB, a transmission reception point (TRP), an evolved NodeB (evolved Node B, eNB), a radio network controller (RNC), a NodeB (NB), a base station controller (BSC), a base transceiver station (BTS), a home base station (for example, a home evolved NodeB or a home Node B, HNB), a baseband unit (BBU), or a wireless fidelity (Wi-Fi) access point (AP). In a network structure, the network device may include a centralized unit ( ) node, a distributed unit (DU) node, a RAN device including a CU node and a DU node, or a RAN device including a control plane CU node (CU-CP node), a user plane CU node (CU-UP node), and a DU node.

The access device serves a cell. The terminal device communicates with the access device by using a transmission resource (for example, a frequency domain resource or a spectrum resource) used for the cell. The cell may be a cell corresponding to the access device (for example, a base station). The cell may belong to a macro base station, or a base station corresponding to a small cell (small cell). The small cell herein may include a metro cell, a micro cell, a pico cell, a femto cell, or the like. These small cells have features of small coverage and a low transmit power, and are suitable for providing a high-rate data transmission service.

In addition, a plurality of cells may simultaneously work in a same frequency band on a carrier in the LTE system or the 5G system. In some special scenarios, it may be considered that a concept of the carrier is equivalent to that of the cell. For example, in a carrier aggregation (CA) scenario, both a carrier index of a secondary component carrier and a cell identifier (Cell ID) of a secondary cell that works on the secondary component carrier are carried when the secondary component carrier is configured for UE. In this case, it may be considered that the concept of the carrier is equivalent to that of the cell. For example, that the terminal device accesses a carrier is equivalent to that the terminal device accesses a cell.

The communications system in this disclosure may be further applicable to a vehicle to everything (V2X) technology. To be specific, the terminal device in this disclosure may alternatively be a vehicle, for example, an intelligent vehicle or a self-driving vehicle.

Herein, “X” in V2X represents different communication targets, and V2X may include but is not limited to vehicle to vehicle (V2V), vehicle to infrastructure (V2I), vehicle to network (V2N), and vehicle to pedestrian (vehicle to pedestrian, V2P).

In V2X, the access device may configure a “zone” for UE. The zone may also be referred to as a geographical area. After the zone configuration, the world is divided into a plurality of zones, and the zones are defined by reference points, lengths, and widths. When determining a zone identifier (ID), the UE uses a zone length, a zone width, a quantity of zones above the length, a quantity of zones above the width, and a zone reference point to perform a remainder operation. The foregoing information may be configured by the access device.

3. Access Management Function Entity

The access management function entity is mainly configured to perform mobility management, access management, and the like, and may be configured to implement functions, for example, lawful interception and access authorization/authentication, other than session management in functions of a mobility management entity (MME) in an LTE system.

In a 5G communications system, the access management network element may be an access management function (AMF) entity.

In a future communications system, the access management function entity may still be an AMF entity, or may have another name. This is not limited in this disclosure.

4. Session Management Function Entity

The session management function (SMF) entity is mainly configured to: manage a session, allocate and manage an internet protocol (IP) address of a terminal device, select a termination point of a manageable user plane function, a policy control and charging function interface, notify downlink data, and the like.

In a future communications system, the session management network element may still be an SMF entity, or may have another name. This is not limited in this disclosure.

5. Disclosure Function Entity

The disclosure function (DF) entity is configured to perform disclosure-affected data routing, access a network exposure function entity, interact with a policy framework to perform policy control, or the like.

In a future communications system, the disclosure function entity may still be a DF entity, or may have another name. This is not limited in this disclosure.

6. Network Exposure Function Entity

The network exposure function entity (NEF) entity is configured to securely expose various capabilities of the system to the outside for use by a third-party disclosure.

For example, in this disclosure, the NEF may open a time synchronization capability of a communications system (for example, a 5G system), to support application services such as professional audio and video and industrial control.

In a future communications system, the network exposure function entity may still be an NEF entity, or may have another name. This is not limited in this disclosure.

7. User Plane Function Entity

The user plane function (UPF) entity is configured to perform packet routing and forwarding, quality of service (QoS) processing of user plane data, or the like.

In a future communications system, the user plane function entity may still be a UPF entity, or may have another name. This is not limited in this disclosure.

8. Data Network

The data network (DN) is a network that provides data transmission.

9. Policy Control Function Entity

The policy control function (PCF) entity supports a unified policy framework to manage network behavior, provides a policy rule for a network entity to execute, and accesses subscription information of a unified data repository (UDR).

It should be noted that the foregoing “entity” may also be referred to as a network element, a device, an apparatus, a module, or the like. This is not particularly limited in this disclosure. In addition, in this disclosure, for ease of understanding and description, the description of the “entity” is omitted in some descriptions. For example, the SMF entity is referred to as an SMF for short. In this case, the “SMF” should be understood as an SMF network element or an SMF entity. Descriptions of same or similar cases are omitted below.

It may be understood that the foregoing entities or functions may be network elements in a hardware device, or may be software functions running on dedicated hardware, or may be virtualized functions instantiated on a platform (for example, a cloud platform).

It should be understood that the foregoing network elements or entities included in the communications system are merely examples for description. This is not particularly limited in this disclosure.

FIG. 2 is a schematic diagram of another example of this disclosure. As shown in FIG. 2, a communications system in this disclosure may support a latency sensitive network (TSN). Specifically, a TSN system sends time serving information to a TSN node by using the communications system (specifically, the communications system on which a terminal device resides), for example, a 5G system, to implement clock synchronization between TSN nodes in a same time domain. In other words, clock times of all TSN nodes are consistent. In the 5G system, a function module: a device side TSN translator (DS-TT) is deployed on a terminal device, and a function module: a network side TSN translator (NW-TT) is deployed on a user plane function (UPF), to adapt to an external TSN system.

The TSN system sends the time serving information through the TSN node, to implement clock synchronization between the TSN nodes in the same time domain. In other words, the clock times of all the TSN nodes are consistent. In a wireless communications system, a function module: a DS-TT is deployed on a terminal device, and a function module: an NW-TT is deployed on a UPF, to adapt to an external TSN system. As shown in FIG. 2, when the 5G system functions as a TSN bridge, the 5G system may be referred to as a 5GS virtual TSN bridge.

A specific structure of an execution body of a method provided in embodiments of this disclosure is not particularly limited in embodiments of this disclosure, provided that a program that records code for the method provided in embodiments of this disclosure can be run to perform communication according to the method provided in embodiments of this disclosure. For example, the execution body of the method provided in embodiments of this disclosure may be a terminal device, a network device, a function module that can invoke and execute the program in a terminal device or a network device, or a component (for example, a chip or a circuit) that may be applied to a terminal device or a network device.

In addition, aspects or features of this disclosure may be implemented as a method, an apparatus, or a product that uses standard programming and/or engineering technologies. The term “product” used in this disclosure covers a computer program that can be accessed from any computer-readable component, carrier or medium. For example, a computer-readable medium may include but is not limited to: a magnetic storage component (for example, a hard disk, a floppy disk, or a magnetic tape), an optical disc (for example, a compact disc (CD) and a digital versatile disc (DVD)), a smart card, and a flash memory component (for example, an erasable programmable read-only memory (EPROM), a card, a stick, or a key drive). In addition, various storage media described in this specification may represent one or more devices and/or other machine-readable media that are configured to store information. The term “machine-readable media” may include but is not limited to a radio channel, and various other media that can store, include and/or carry instructions and/or data.

In the communications system in this disclosure, a plurality of time synchronization capabilities (or a plurality of clock sources, for example, GMs) may be provided, to support time synchronization with a variety of precision.

For example, the time synchronization capability may include but is not limited to the following capabilities:

1. A capability of performing synchronization based on an internal clock source (for example, a 5G GM) of a system (for example, a 5G system);

2. A capability of performing synchronization based on a TSN clock source (for example, a TSN GM);

3. A capability of performing synchronization based on a clock source of another possible type in the future.

In addition, there can be a plurality of different clock sources in a same type of time synchronization capability. For example, in a time synchronization type of the TSN, synchronization may be performed based on a TSN clock source 1 (a TSN GM 1) in a clock domain in which a TSN node 1 is located as shown in FIG. 2. Alternatively, synchronization may be performed based on a TSN clock source 2 (a TSN GM 2) in a clock domain in which a TSN node 2 is located as shown in FIG. 2. Different clock sources may have different synchronization precision. For example, precision of the 5G GM may be 0.1 milliseconds (ms), precision of the TSN GM 1 may be 0.001 ms, and precision of the TSN GM 2 may be 0.001 ms.

For example, the solution provided in this disclosure may support a time synchronization capability based on three clock sources of two types, for example, synchronization based on a clock source (the 5G GM) of the 5G system and synchronization based on a TSN master clock source (the TSN GM 1 and the TSN GM 2).

The foregoing three clock sources provide different time synchronization precision, which are exposed to a third-party disclosure through a NEF. Different disclosures can use one or more time synchronization capabilities based on disclosure requirements.

For example, a video surveillance disclosure may choose to use TSN GM 1-based time synchronization, a production control disclosure may also choose to use TSN GM 1-based time synchronization, and a video conference disclosure may choose to use 5G GM-based time synchronization.

In this disclosure, time information may be carried and transferred between devices (including between devices in a system, or between a device in a system and a device outside the system) by using a time synchronization packet, for example, a generic precision time protocol (gPTP) packet (or a message).

Therefore, all devices in the system, for example, network elements such as UE and a UPF in the 5G system, and UE or a network device outside the 5G system may perform time synchronization based on the time information in the received gPTP packet.

By way of example, and not limitation, the time information may include but is not limited to a sending moment of the time synchronization packet, a time offset, and the like.

It should be understood that the foregoing time information and specific content of the time synchronization packet are merely examples for description. This is not particularly limited in this disclosure. The time synchronization packet in this disclosure may be the same as or similar to a packet used for a time synchronization process in a conventional technology. In addition, the time information in this disclosure may be the same as or similar to information used for time synchronization in the conventional technology, or in other words, information carried in the time synchronization packet in the conventional technology.

In this disclosure, the terminal device has two states for a clock source: an activated state and a deactivated state.

In addition, the terminal device may switch the clock source between the activated state and the deactivated state based on an indication of the network device (for example, an SMF).

In addition, in the two states, the terminal device processes a time synchronization packet of the clock source in different manners.

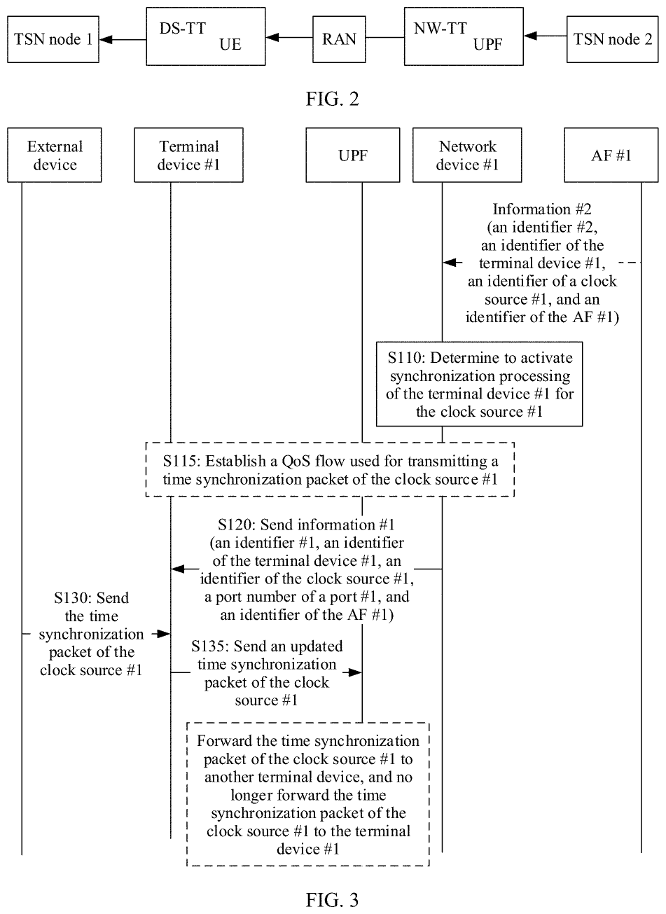

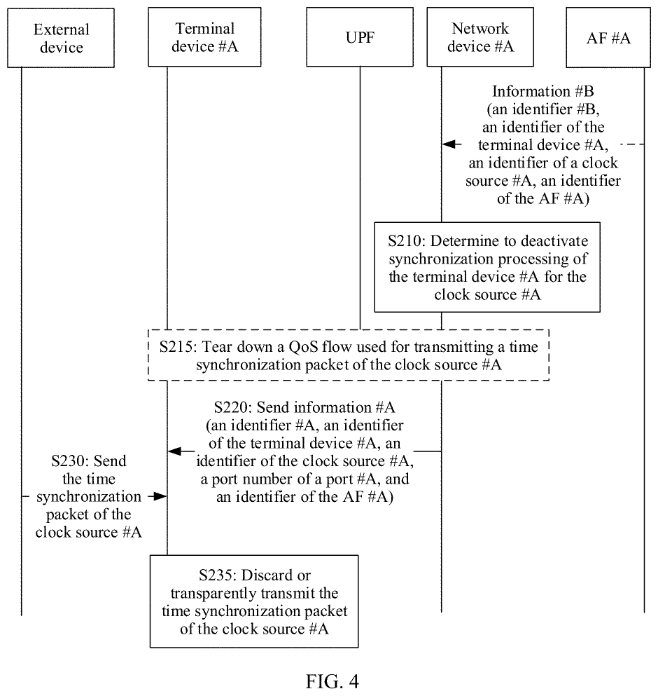

The following separately describes state switching and processing manners in different states in detail with reference to FIG. 3 and FIG. 4.

FIG. 3 shows an activation process and a manner of processing a time synchronization packet in an activated state. As shown in FIG. 3, in S110, a network device #1 (namely, an example of a network device) may determine that a terminal device #1 (namely, an example of a terminal device) needs to be activated to perform a time synchronization process for a TSN GM #1 (namely, an example of a first clock source).

By way of example, and not limitation, the network device #1 may include an SMF.

In this case, the SMF and the terminal device may communicate with each other by using, for example, an AMF and an access network device.

For example, the SMF and the terminal device may communicate with each other by using, for example, a non-access stratum (NAS) message.

It should be understood that the foregoing SMF is merely an example of the network device #1. This is not particularly limited in this disclosure. For example, the network device #1 may alternatively be an AMF, an access device, or the like. This is not particularly limited in this disclosure. For ease of understanding, the following describes in detail a method for processing the time synchronization packet in this disclosure by using the SMF as the network device #1.

In this case, the network device #1 may receive, by using, for example, an NEF, information #2 (namely, an example of second indication information) sent by an AF (denoted as an AF #1). The AF #1 may be an AF that provides a service #1 for the terminal device #1.

The service #1 needs to use TSN GM #1-based time synchronization, or a service #1 requirement on time synchronization precision is to provide time synchronization precision for the TSN GM #1. In addition, the service #1 may be a service that the terminal device #1 needs to access.

That is, in this disclosure, the information #2 may request to activate time synchronization processing of the terminal device #1 for the TSN GM #1.

In other words, the information #2 may requests to enable a time synchronization capability of the terminal device #1 for the TSN GM #1.

In other words, the information #2 may request the terminal device #1 to enter an activated state of the TSN GM #1 (or time synchronization processing of the TSN GM #1).

In other words, the information #2 may request the terminal device #1 to switch the TSN GM #1 (or time synchronization processing of the TSN GM #1) to the activated state.

Therefore, the network device #1 may determine, based on the information #2, that the terminal device #1 needs to be activated to perform the time synchronization process for the TSN GM #1.

It should be understood that the foregoing manner in which the network device #1 determines that the terminal device #1 needs to be activated to perform the time synchronization process for the TSN GM #1 is merely an example for description. This is not particularly limited in this disclosure. For example, the network device may also sense a service that the terminal device currently needs to access, and determine, based on a service requirement on time synchronization precision, whether the terminal device needs to be activated to perform a time synchronization process for a clock source corresponding to the requirement on time synchronization precision.

Optionally, in this disclosure, the network device #1 may further record a time synchronization status (for example, an activated state or a deactivated state) of the terminal device #1 for the TSN GM #1. For example, the network device #1 may determine a current time synchronization status of the terminal device #1 for the TSN GM #1 based on a history of an activation request or a deactivation request that is received from the AF for the TSN GM #1.

Therefore, the network device #1 may determine, based on the current time synchronization status of the terminal device #1 for the TSN GM #1 and the information #2, whether the terminal device #1 needs to be activated to perform the time synchronization process for the TSN GM #1.

For example, if the current time synchronization status of the terminal device #1 for the TSN GM #1 is deactivated, when receiving the information #2, the network device #1 may determine that the terminal device #1 needs to be activated to perform the time synchronization process for the TSN GM #1.

By way of example, and not limitation, the information #2 may include an identifier of the terminal device #1, an identifier of the TSN GM #1, and an indication identifier #2 (namely, an example of a second identifier).

Optionally, the identifier of the terminal device #1 may include a device identifier (for example, a mobile phone number, an internet protocol address, or a network temporary identifier) of the terminal device #1.

The identifier #2 may include two optional values, for example, on and off.

When a value of the identifier #2 is on, the network device may determine that the information #2 requests to activate time synchronization processing of the terminal device #1 for the TSN GM #1.

When a value of the identifier #2 is off, the network device may determine that the information #2 requests to deactivate time synchronization processing of the terminal device #1 for the TSN GM #1.

Alternatively, the identifier #2 may have a specified format or carry a specified bit sequence #1, and the bit sequence #1 indicates that a clock source indicated by the identifier carried in the information #2 needs to be activated.

Alternatively, the identifier #2 may have a specified format or carry a specified bit sequence #2, and the bit sequence #2 indicates that a clock source indicated by the identifier carried in the information #2 needs to be deactivated.

As described above, the information #2 indicates to activate time synchronization processing of the terminal device #1 for the TSN GM #1. In this case, a value of the identifier #2 is on.

Optionally, the information #2 may further include an identifier of the AF #1.

Optionally, in S115, the network device #1 (for example, the SMF) may further establish (or configure) a QoS flow #1.

For example, when the network device #1 determines, based on the identifier #2, that the terminal device #1 needs to be activated to perform time synchronization for the TSN GM #1, the network device #1 triggers an establishment procedure of the QoS flow #1.

Specifically, in this disclosure, a time synchronization packet may be transmitted between the terminal device and a device such as a UPF by using a QoS flow, that is, the QoS flow in a protocol data unit session (PDU Session) of the terminal device. For example, the network device #1 may establish the QoS flow #1 by triggering a modification procedure of the PDU session.

For example, in this disclosure, for a terminal device, each activated and/or to-be-activated clock source may correspond to one QoS flow.

For another example, for a terminal device, each type of activated and/or to-be-activated clock source may correspond to one QoS flow.

For another example, for a terminal device, all activated and/or to-be-activated clock sources may share one QoS flow.

Therefore, in this disclosure, when determining that time synchronization of the terminal device #1 for the TSN GM #1 needs to be activated, the network device #1 may establish a QoS flow, namely, the QoS flow #1, used for transmitting a time synchronization packet of the TSN GM #1.

A process of establishing the QoS flow in this disclosure may be similar to a process of establishing a QoS flow in the conventional technology. To avoid repetition, detailed descriptions are omitted herein.

It should be noted that, in this disclosure, the time synchronization packet is transmitted between the terminal device and the UPF by using the PDU session. Therefore, after the UPF receives the time synchronization packet (for example, a gPTP packet) from a PDU session, it indicates that UE that uses the PDU session completes time synchronization processing based on a clock source of the time synchronization packet. Therefore, the UPF may no longer send the gPTP packet by using the PDU session. This can reduce energy consumption of the UPF and the terminal device, and reduce signaling overheads.

In the conventional technology, there is only one TSN-dedicated PDU session between a pair of ingress and egress interfaces (it is assumed that the ingress interface is on an NW-TT of the UPF, and the egress interface is on a DS-TT of UE). The PDU session is used for transmitting both a time synchronization packet and a TSN service packet.

According to the solution provided in this disclosure, the time synchronization packet is transmitted by using the QoS flow (for example, an existing or newly established QoS flow), and a PDU session does not need to be additionally established for synchronization practice. This complies with an architecture design idea of the conventional technology, and can be better compatible with the conventional technology, and improve practicability of this disclosure.

Optionally, in this disclosure, the network device #1 may further record or store a status (specifically, an activated state or a deactivated state) of the terminal device #1 for each clock source.

Therefore, the network device #1 may further determine, based on the information #2 and the status of the terminal device #1 for the TSN GM #1, whether to establish the QoS flow #1.

Specifically, if the status of the terminal device #1 for the TSN GM #1 is activated, and the terminal device #1 performs synchronization for the TSN GM #1, or an AF other than the AF #1 sends a request to the network device #1 to activate synchronization of the terminal device #1 for the TSN GM #1, it indicates that the network device #1 establishes the QoS flow used for transmitting the time synchronization packet of the TSN GM #1. In this case, the QoS flow #1 does not need to be established again.

In S120, the network device #1 sends information #1 (namely, an example of first indication information) to the terminal device #1. The information #1 instructs the terminal device #1 to activate the TSN GM #1, or the information #1 instructs the terminal device #1 to activate time synchronization processing for the TSN GM #1.

Specifically, after receiving the information #2 (that is, information requests to activate synchronization of the terminal device #1 for the TSN GM #1), the network device #1 may generate the information #1.

Alternatively, after receiving the information #2 (that is, the information requests to activate synchronization of the terminal device #1 for the TSN GM #1), the network device #1 may perform determining. To be specific, if the information #2 is first information that is received by the network device #1 and that requests to activate synchronization of the terminal device #1 for the TSN GM #1, the network device #1 may generate the information #1.

In addition, if the information #2 is not the first information that is received by the network device #1 and that requests to activate synchronization of the terminal device #1 for the TSN GM #1, or if synchronization of the terminal device #1 for the TSN GM #1 is already in the activated state, or before the information #2, if the network device #1 receives information that requests to activate synchronization of the terminal device #1 for the TSN GM #1, the network device #1 may not generate (or send) the information #1.

For example, in this disclosure, the network device may indicate, by using activation indication information, the terminal device to activate or deactivate a clock source.

The information #1 carries the identifier of an indicated object (namely, the TSN GM #1).

The information #1 carries the identifier of the terminal device #1.

Optionally, the information #1 may further carry a port number of a port #1. The port #1 includes a port configured to transmit a clock packet of the TSN GM #1.

Specifically, in this disclosure, the network device #1 may obtain and record a correspondence between each port of the terminal device #1 and each clock source, where one port is configured to transmit a clock packet of the corresponding clock source.

Therefore, the network device #1 may determine the port #1 based on the identifier of the TSN GM #1 and the foregoing correspondence.

Further, the terminal device may activate, based on the port number carried in the information #1, time synchronization processing of a clock source corresponding to the port.

It should be understood that the foregoing solution in which the information #1 carries the port number of the port #1 is merely an example for description. This disclosure is not limited thereto. For example, when receiving the information #1, the terminal device #1 may activate time synchronization processing for the TSN GM #1 on all ports of the terminal device #1.

In this disclosure, the information #1 may include an identifier #1 (namely, an example of a first identifier).

The identifier #1 may include two optional values, for example, on and off.

In this disclosure, on may also be referred to as an activation identifier, and off may also be referred to as a deactivation identifier.

When a value of the identifier #1 is on, the terminal device may determine that the information #1 requests to activate time synchronization processing for the TSN GM #1.

When a value of the identifier #1 is off, the terminal device may determine that the information #1 requests to deactivate time synchronization processing for the TSN GM #1.

Alternatively, in this disclosure, on and off may correspond to different bits (or bit sequences).

To be specific, the information #1 may include an indication bit, and the indication bit carries the bit used for distinguishing between the activated state (that is, on) and the deactivated state (that is, off).

Therefore, the terminal device may determine, based on a bit (or a bit sequence) carried in an indication bit of the received activation indication information, whether to activate or deactivate a clock source indicated by an identifier carried in the activation indication information.

For example, if “1” indicates activation, and “0” indicates deactivation, the information #1 may be a bit “1” carried in the indication bit and carries the activation indication information that includes the identifier of the TSN GM #1.

As described above, the information #1 indicates to activate time synchronization processing for the TSN GM #1. In this case, a value of the identifier #1 is on.

Optionally, the information #1 may further include an identifier of the AF #1.

In an implementation, the network device #1 may establish the QoS flow used for transmitting the clock synchronization packet of the TSN GM #1 in step S115. Alternatively, in another implementation, after step S110, the network device #1 sends the information #1 to the terminal device #1 in step S120. After receiving the information #1, the network device #1 triggers, based on the activation identifier in the information #1, the establishment procedure of the QoS flow used for transmitting the clock synchronization packet of the TSN GM #1.

In S130, the terminal device #1 may periodically receive the time synchronization packet (denoted as a time synchronization packet #1) of the TSN GM #1 from an external device.

Specifically, the external device may be a device outside a system in which the terminal device #1 is located, for example, a sensing terminal station (time-aware end-station) of the TSN GM #1.

In S135, the terminal device #1 may process the time synchronization packet #1 based on the processing manner (namely, an example of the first processing manner) corresponding to the activated state.

It should be noted that, in this disclosure, the time synchronization packet #1 may be an initial time synchronization packet that is of the TSN GM #1 and that is received by the terminal device #1 after the terminal device #1 receives the information #1.

Manner a

The terminal device #1 updates information carried in the time synchronization packet #1 (for example, information carried in a field of a packet sending moment), and sends the updated time synchronization packet #1 to the external device.

Manner b

In this disclosure, a time synchronization packet may be transmitted between the terminal device and the device such as the UPF by using a quality of service flow (QoS flow), that is, the QoS flow in the protocol data unit session (PDU Session) of the terminal device.

For example, in this disclosure, for the terminal device, each activated and/or to-be-activated clock source may correspond to one QoS flow.

For another example, for the terminal device, each type of activated and/or to-be-activated clock source may correspond to one QoS flow.

For another example, for the terminal device, all activated and/or to-be-activated clock sources may share one QoS flow.

Therefore, in this disclosure, the terminal device #1 may establish the QoS flow #1 used for transmitting the time synchronization packet of the TSN GM #1.

It should be understood that the process of establishing the QoS flow #1 in this disclosure may be performed under control of the SMF. In addition, the process of establishing the QoS flow in this disclosure may be similar to the process of establishing the QoS flow in the conventional technology. To avoid repetition, detailed descriptions are omitted herein.

The foregoing describes a manner of processing a time packet by using the time synchronization packet of the TSN GM as an example. However, the present invention is not limited thereto. The time synchronization packet in this disclosure may also be any other GM.

It should be noted that the foregoing manner a and manner b may be specified by a communications system or a communications protocol. In this case, after receiving the information #1, the terminal device #1 may directly process the time synchronization packet for the TSN GM #1 in one or more of the manner a and the manner b.

Alternatively, the network device #1 may further send information #3 to the terminal device #1. The information #3 indicates the one or more of the foregoing manner a and manner b, so that the terminal device #1 may process the time synchronization packet for the TSN GM #1 in a manner indicated by the information #3.

In addition, the information #3 and the information #1 may be same information, or may be different information. This is not particularly limited in this disclosure.

In other words, the information #3 and the information #1 may be sent synchronously or asynchronously. This is not particularly limited in this disclosure.

Optionally, the terminal device #1 may further perform time synchronization for the TSN GM #1 after receiving the information #1.

Alternatively, the information #1 may trigger the terminal device #1 to perform time synchronization for the TSN GM #1.

In addition, in this disclosure, the manner a and the manner b may be jointly performed. To be specific, the terminal device #1 may perform the steps in the manner a and the manner b. In addition, an execution sequence of the steps in the manner a and the manner b is not particularly limited.

FIG. 4 shows a deactivation process and a manner of processing a time synchronization packet in a deactivated state. As shown in FIG. 4, in S210, a network device #A (namely, an example of a network device) may determine that a terminal device #A (namely, an example of a terminal device) needs to be deactivated to perform a time synchronization process for a TSN GM #A (namely, an example of a first clock source).

By way of example, and not limitation, the network device #A may include an SMF.

It should be understood that the foregoing SMF is merely an example of the network device #A. This is not particularly limited in this disclosure. For example, the network device #A may alternatively be an AMF, an access device, or the like. This is not particularly limited in this disclosure. For ease of understanding, the following describes in detail a method for processing the time synchronization packet in this disclosure by using the SMF as the network device #A.

In this case, the network device #A may receive, by using, for example, an NEF, information #B (that is, an example of second indication information) sent by an AF (denoted as an AF #A). The AF #A may be an AF that provides a service #A for the terminal device #A.

The service #A needs to use TSN GM #A-based time synchronization, or a service #A requirement on time synchronization precision is to provide time synchronization precision for the TSN GM #A. In addition, the service #A may be a service that the terminal device #A needs to end access.

That is, in this disclosure, the information #B may request to deactivate time synchronization processing of the terminal device #A for the TSN GM #A.

In other words, the information #B may request to disable a time synchronization capability of the terminal device #A for the TSN GM #A.

In other words, the information #B may request the terminal device #A to enter a deactivated state of the TSN GM #A (or time synchronization processing of the TSN GM #A).

In other words, the information #B may request the terminal device #A to switch the TSN GM #A (or time synchronization processing of the TSN GM #A) to the deactivated state.

Therefore, the network device #A may determine, based on the information #B, that the terminal device #A needs to be deactivated to perform the time synchronization process for the TSN GM #A.

It should be understood that the foregoing manner in which the network device #A determines that the terminal device #A needs to be deactivated to perform the time synchronization process for the TSN GM #A is merely an example for description. This is not particularly limited in this disclosure. For example, the network device may also sense a service that the terminal device currently needs to end access, and deactivate a clock source used for the service.

Optionally, in this disclosure, the network device #A may further record a time synchronization status (for example, a deactivated state or a state of removing deactivation) of the terminal device #A for the TSN GM #A. For example, the network device #A may determine a current time synchronization status of the terminal device #A for the TSN GM #A based on a history of a deactivation request or a request of removing deactivation that is received from the AF for the TSN GM #A.

Therefore, the network device #A may determine, based on the current time synchronization status of the terminal device #A for the TSN GM #A and the information #B, whether the terminal device #A needs to be deactivated to perform the time synchronization process for the TSN GM #A.

For example, if the current time synchronization status of the terminal device #A for the TSN GM #A is activated, when receiving the information #B, the network device #A may determine that the terminal device #A needs to be deactivated to perform the time synchronization process for the TSN GM #A.

By way of example, and not limitation, the information #B may include an identifier of the terminal device #A, an identifier of the TSN GM #A, and an indication identifier #B (namely, an example of a second identifier).

Optionally, the identifier of the terminal device #A may include a device identifier (for example, a mobile phone number, an internet protocol address, or a network temporary identifier) of the terminal device #A.

The identifier #B may include two optional values, for example, on and off.

When a value of the identifier #B is on, the network device may determine that the information #B requests to activate time synchronization processing of the terminal device #A for the clock source #A.

When a value of the identifier #B is off, the network device may determine that the information #B requests to deactivate time synchronization processing of the terminal device #A for the clock source #A.

Alternatively, the identifier #B may have a specified format or carry a specified bit sequence #A, and the bit sequence #A indicates that a clock source indicated by the identifier carried in the information #B needs to be activated.

Alternatively, the identifier #B may have a specified format or carry a specified bit sequence #B, and the bit sequence #B indicates that a clock source indicated by the identifier carried in the information #B needs to be deactivated.

As described above, the information #B indicates to deactivate time synchronization processing of the terminal device #A for the clock source #A. In this case, a value of the identifier #B is off.

Optionally, the information #B may further include an identifier of the AF #A.

Optionally, in S215, the network device #A (for example, the SMF) may further tear down (or release) a QoS flow #A.

For example, when the network device #A determines, based on the identifier #B, that the terminal device #A needs to be deactivated to perform time synchronization for the clock source #A, the network device #A triggers a teardown procedure of the QoS flow #A.

Specifically, after receiving the information #B (that is, information requests to deactivate synchronization of the terminal device #A for the TSN GM #A), the network device #A may tear down the QoS flow #A.

Alternatively, after receiving the information #B (that is, the information requests to deactivate synchronization of the terminal device #A for the TSN GM #A), the network device #A may perform determining. To be specific, if currently no AF other than the AF #A needs to provide a service for the terminal device #A based on the TSN GM #A, the network device #A may tear down the QoS flow #A.

In addition, if currently, in addition to the AF #A, there is another AF that needs to provide a service for the terminal device #A based on the TSN GM #A, the QoS flow #A may not be torn down.

Specifically, in this disclosure, a time synchronization packet may be transmitted between the terminal device and a device such as a UPF by using a QoS flow, that is, the QoS flow in a protocol data unit session of the terminal device.

For example, in this disclosure, for the terminal device, each activated and/or to-be-activated clock source may correspond to one QoS flow.

For another example, for the terminal device, each type of activated and/or to-be-activated clock source may correspond to one QoS flow.

For another example, for the terminal device, all activated and/or to-be-activated clock sources may share one QoS flow.

Therefore, in this disclosure, when determining that time synchronization of the terminal device #A for the TSN GM #A needs to be deactivated, the network device #A may tear down a QoS flow, namely, the QoS flow #A, used for transmitting a time synchronization packet of the TSN GM #A.

A process of tearing down the QoS flow in this disclosure may be similar to a process of tearing down a QoS flow in the conventional technology. To avoid repetition, detailed descriptions are omitted herein.

In S220, the network device #A sends information #A (namely, an example of first indication information) to the terminal device #A. The information #A instructs the terminal device #A to deactivate the TSN GM #A, or the information #A instructs the terminal device #A to deactivate time synchronization processing for the TSN GM #A.

Specifically, after receiving the information #B (that is, information requests to deactivate synchronization of the terminal device #A for the TSN GM #A), the network device #A may generate the information #A.

Alternatively, after receiving the information #B (that is, the information requests to deactivate synchronization of the terminal device #A for the TSN GM #A), the network device #A may perform determining. To be specific, if currently no AF other than the AF #A needs to provide a service for the terminal device #A based on the TSN GM #A, the network device #A may generate the information #A.

In addition, if currently, in addition to the AF #A, there is another AF that needs to provide a service for the terminal device #A based on the TSN GM #A, the information #A may not be generated or sent.

For example, in this disclosure, the network device may indicate, by using deactivation indication information, the terminal device to deactivate or remove deactivation for a clock source.

The information #A may carry the identifier of an indicated object (that is, the TSN GM #A).

Optionally, the information #A may further carry a port number of a port #A. The port #A includes a port configured to transmit a clock packet of the TSN GM #A.

Specifically, in this disclosure, the network device #A may obtain and record a correspondence between each port of the terminal device #A and each clock source, where one port is configured to transmit a clock packet of the corresponding clock source.

Therefore, the network device #A may determine the port #A based on the identifier of the TSN GM #A and the foregoing correspondence.

Further, the terminal device may activate, based on the port number carried in the information #A, time synchronization processing of a clock source corresponding to the port.

It should be understood that the foregoing solution in which the information #A carries the port number of the port #A is merely an example for description. This disclosure is not limited thereto. For example, when receiving the information #A, the terminal device #1 may activate time synchronization processing for the TSN GM #A on all ports of the terminal device #A.

In addition, in this disclosure, the activated state and the deactivated state may correspond to different bits (or bit sequences).

In addition, the deactivation indication information may include an indication bit, and the indication bit carries the bit used for distinguishing between the activated state and the deactivated state.

Therefore, the terminal device may determine, based on a bit (or a bit sequence) carried in an indication bit of the received deactivation indication information, whether to activate or deactivate a clock source indicated by an identifier carried in the deactivation indication information.

For example, if “1” indicates activation, and “0” indicates deactivation, the information #A may be a bit “0” carried in the indication bit and carries the deactivation indication information that includes the identifier of the TSN GM #A.

In other words, the information #A may include the identifier of the terminal device #A and the identifier of the TSN GM #A.

Optionally, the information #A may further include an identifier of the AF #A.

Optionally, the identifier of the terminal device #A may include the device identifier (for example, the mobile phone number, the internet protocol address, or the network temporary identifier) of the terminal device #A, the port number of the terminal device #A, or the like.

In S230, the terminal device #A may periodically receive the time synchronization packet (denoted as a time synchronization packet #A) of the TSN GM #A from an external device.

Specifically, the external device may be a device outside a system in which the terminal device #A is located, for example, a sensing terminal station (time-aware end-station) of the TSN GM #A.

In S235, the terminal device #A may process the time synchronization packet #A based on the processing manner (namely, an example of a second processing manner) corresponding to the deactivated state.

It should be noted that, in this disclosure, the time synchronization packet #A may be an initial time synchronization packet that is of the TSN GM #A and that is received by the terminal device #A after the terminal device #A receives the information #A.

Manner c

The terminal device #A may transparently transmit the time synchronization packet #A to a device such as the UPF.

In this case, the UPF may forward the received time synchronization packet #A to another terminal device in the system.

Manner d

The terminal device #A may discard the time synchronization packet #A.

Manner e

In this disclosure, a time synchronization packet may be transmitted between the terminal device and the device such as the UPF by using a quality of service flow (QoS flow), that is, the QoS flow in the protocol data unit session (PDU Session) of the terminal device.

For example, in this disclosure, for the terminal device, each deactivated and/or to-be-deactivated clock source may correspond to one QoS flow.

For another example, for the terminal device, each type of deactivated and/or to-be-deactivated clock source may correspond to one QoS flow.

For another example, for the terminal device, all deactivated and/or to-be-deactivated clock sources may share one QoS flow.

Therefore, in this disclosure, the terminal device #A may tear down (delete) the QoS flow #A used for transmitting the time synchronization packet of the TSN GM #A.

It should be understood that the process of tearing down the QoS flow #A in this disclosure may be performed under control of the SMF. In addition, the process of tearing down the QoS flow in this disclosure may be similar to a process of tearing down a QoS flow in the conventional technology. To avoid repetition, detailed descriptions are omitted herein.

The foregoing describes a manner of processing a time packet by using the time synchronization packet of the TSN GM as an example. However, the present invention is not limited thereto. The time synchronization packet in this disclosure may also be any other GM.

It should be noted that the foregoing manner c to manner e may be specified by a communications system or a communications protocol. In this case, after receiving the information #A, the terminal device #A may directly process the time synchronization packet for the TSN GM #A in one or more manners of the manner c to the manner e.

Alternatively, the network device #A may further send information #C to the terminal device #A. The information #C indicates the one or more of the foregoing manner c to manner e, so that the terminal device #A may process the time synchronization packet for the TSN GM #A in a manner indicated by the information #C.

In addition, the information #C and the information #A may be same information, or may be different information. This is not particularly limited in this disclosure.

In other words, the information #C and the information #A may be sent synchronously or asynchronously. This is not particularly limited in this disclosure.

Optionally, the terminal device #1 may further stop time synchronization for the TSN GM #1 after receiving the information #A.

Alternatively, the information #1 may trigger the terminal device #1 to stop time synchronization for the TSN GM #1.

In addition, it should be noted that the terminal device #1 and the terminal device #A may be a same terminal device or different terminal devices. This is not particularly limited in this disclosure. In addition, the TSN GM #1 and the TSN GM #A may be a same clock source, or may be different clock sources. This is not particularly limited in this disclosure.

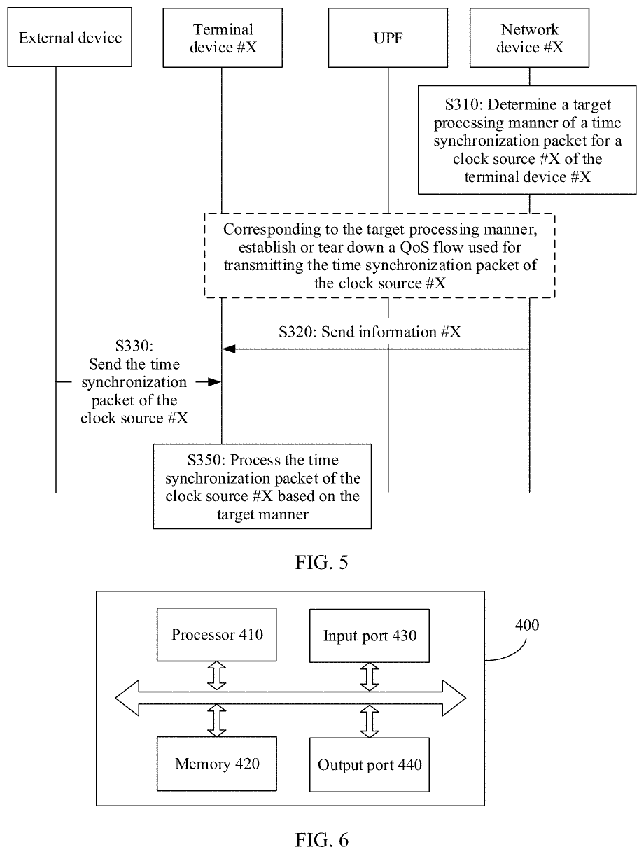

FIG. 5 shows an example of a process of processing a time synchronization packet according to this disclosure. As shown in FIG. 5, in S310, a network device #X (namely, an example of a network device) determines a target processing manner of a time synchronization packet for a TSN GM #X (namely, an example of a first clock source) of a terminal device #X.

By way of example, and not limitation, the target processing manner may include one or more of the foregoing manner a or manner b.

Alternatively, the target processing manner may include one or more of the foregoing manner c to manner e.

By way of example, and not limitation, the network device #X may include an SMF.

It should be understood that the foregoing SMF is merely an example of the network device #X. This is not particularly limited in this disclosure. For example, the network device #X may alternatively be an AMF, an access device, or the like. This is not particularly limited in this disclosure. For ease of understanding, the following describes in detail a method for processing the time synchronization packet in this disclosure by using the SMF as the network device #X.

The network device #X may determine the target processing manner based on whether the TSN GM #X is activated or deactivated. For example, if the TSN GM #X needs to be activated, one or more manners are selected from the foregoing manner a or manner b as the target processing manner. For another example, if the TSN GM #X needs to be deactivated, one or more manners are selected from the foregoing manner c to manner e as the target processing manner.

In addition, a method and a process in which the network device #X determines whether the TSN GM #X is activated or deactivated may be similar to the method and the process in which the network device #1 or the network device #A determines whether a clock source is activated or deactivated. To avoid repetition, detailed descriptions are omitted herein.

In S320, the network device #X sends information #X (namely, an example of first indication information) to the terminal device #X. The information #X indicates the target processing manner.

Optionally, the information #A may carry an identifier of the TSN GM #X.

Optionally, the information #A may carry an identifier of the terminal #X.

In S330, the terminal device #A may periodically receive the time synchronization packet (denoted as a time synchronization packet #X) of the TSN GM #X from an external device.

Specifically, the external device may be a device outside a system in which the terminal device #X is located, for example, a sensing terminal station (time-aware end-station) of the TSN GM #A.

In S335, the terminal device #X may process the time synchronization packet of the TSN GM #X based on the target processing manner. In addition, the specific process may be similar to the processing process of the terminal device #1 or the terminal device #A. To avoid repetition, detailed descriptions are omitted herein.

According to the foregoing method, FIG. 6 is a schematic diagram of an apparatus 400 for processing a time synchronization packet according to an embodiment of this disclosure.

The apparatus 400 may be a terminal device, or may be a chip or a circuit, for example, a chip or a circuit that may be disposed in a terminal device.

The apparatus 400 may include a processing unit 410 (namely, an example of a processing unit), and optionally, may further include a storage unit 420. The storage unit 420 is configured to store instructions.

In a possible manner, the processing unit 410 is configured to execute the instruction stored in the storage unit 420, so that the apparatus 400 implements the steps performed by the terminal device in the foregoing method.

Further, the apparatus 400 may further include an input port 430 (namely, an example of a communication unit) and an output port 440 (namely, another example of a transceiver unit). Further, the processing unit 410, the storage unit 420, the input port 430, and the output port 440 may communicate with each other through an internal connection path, to transmit a control signal and/or a data signal. The storage unit 420 is configured to store a computer program. The processing unit 410 may be configured to invoke the computer program from the storage unit 420 and run the computer program, to complete the steps of the terminal device in the foregoing method. The storage unit 420 may be integrated into the processing unit 410, or may be disposed separately from the processing unit 410.

Optionally, in a possible manner, the input port 430 may be a receiver, and the output port 440 is a transmitter. The receiver and the transmitter may be a same physical entity or different physical entities. When the receiver and the transmitter are a same physical entity, the receiver and the transmitter may be collectively referred to as a transceiver.

Optionally, in a possible manner, the input port 430 is an input interface, and the output port 440 is an output interface.

In an implementation, it may be considered that functions of the input port 430 and the output port 440 are implemented by using a transceiver circuit or a dedicated transceiver chip. It may be considered that the processing unit 410 is implemented by using a dedicated processing chip, a processing circuit, a processing unit, or a general-purpose chip.

In another implementation, it may be considered that the terminal device provided in this embodiment of this disclosure is implemented by using a general-purpose computer. To be specific, program code for implementing functions of the processing unit 410, the input port 430, and the output port 440 is stored in the storage unit 420, and a general-purpose processing unit executes the code in the storage unit 420 to implement the functions of the processing unit 410, the input port 430, and the output port 440.

In an implementation, the input port 430, namely, the transceiver unit, is for the terminal device to receive a time synchronization packet of a first clock source from an external device, and receive first indication information from a network device. The first indication information instructs the terminal device to enter a time synchronization activated state of the first clock source, or the first indication information instructs the terminal device to enter a time synchronization deactivated state of the first clock source.

The processing unit 410 is configured to process the time synchronization packet of the first clock source based on the first indication information.

Optionally, when the first indication information instructs the terminal device to enter the activated state,

the processing unit 410 is configured to update, based on the first indication information, information carried in the time synchronization packet of the first clock source, and forward the time synchronization packet of the first clock source to a user plane function UPF entity; or

the processing unit 410 is configured to establish a first QoS flow based on the first indication information. The first QoS flow is used for transmitting the time synchronization packet of the first clock source.

Optionally, when the first indication information indicates to enter the deactivated state,

the processing unit 410 is configured to discard the time synchronization packet of the first clock source based on the first indication information;

the processing unit 410 is configured to transparently transmit the time synchronization packet of the first clock source based on the first indication information; or

the processing unit 410 is configured to tear down the first QoS flow based on the first indication information. The first QoS flow is used for transmitting the time synchronization packet of the first clock source.

Optionally, the processing unit 410 is configured to: if the first indication information indicates to enter the activated state, perform time synchronization of the first clock source based on the first indication information.

Optionally, the processing unit 410 is configured to: if the first indication information indicates to enter the deactivated state, stop time synchronization of the first clock source based on the first indication information.

Functions and actions of the modules or units in the apparatus 400 enumerated above are merely examples for description. When the apparatus 400 is configured on or is a terminal device, the modules or units in the apparatus 400 may be configured to perform actions or processing processes performed by the terminal device (for example, the terminal device #1, the terminal device #A, or the terminal device #X) in the foregoing method. To avoid repetition, detailed descriptions are omitted herein.

For concepts, explanations, detailed descriptions, and other steps of the apparatus 400 that are related to the technical solutions provided in embodiments of this disclosure, refer to the descriptions of the content in the foregoing methods or other embodiments. Details are not described herein again.

According to the foregoing method, FIG. 7 is a schematic diagram of an apparatus 500 for processing a time synchronization packet according to an embodiment of this disclosure.

The apparatus 500 may be a network device, or may be a chip or a circuit, for example, a chip or a circuit that may be disposed in a network device.

The apparatus 500 may include a processing unit 510 (namely, an example of a processing unit), and optionally, may further include a storage unit 520. The storage unit 520 is configured to store instructions.

In a possible manner, the processing unit 510 is configured to execute the instruction stored in the storage unit 520, so that the apparatus 500 implements the steps performed by the network device in the foregoing method.

Further, the apparatus 500 may further include an input port 530 (namely, an example of a communication unit) and an output port 540 (namely, another example of a transceiver unit). Further, the processing unit 510, the storage unit 520, the input port 530, and the output port 540 may communicate with each other through an internal connection path, to transmit a control signal and/or a data signal. The storage unit 520 is configured to store a computer program. The processing unit 510 may be configured to invoke the computer program from the storage unit 520 and run the computer program, to complete the steps of the network device in the foregoing method. The storage unit 520 may be integrated into the processing unit 510, or may be disposed separately from the processing unit 510.

Optionally, in a possible manner, the input port 530 may be a receiver, and the output port 540 is a transmitter. The receiver and the transmitter may be a same physical entity or different physical entities. When the receiver and the transmitter are a same physical entity, the receiver and the transmitter may be collectively referred to as a transceiver.

Optionally, in a possible manner, the input port 530 is an input interface, and the output port 540 is an output interface.

In an implementation, it may be considered that functions of the input port 530 and the output port 540 are implemented by using a transceiver circuit or a dedicated transceiver chip. It may be considered that the processing unit 510 is implemented by using a dedicated processing chip, a processing circuit, a processing unit, or a general-purpose chip.

In another implementation, it may be considered that the network device provided in this embodiment of this disclosure is implemented by using a general-purpose computer. To be specific, program code for implementing functions of the processing unit 510, the input port 530, and the output port 540 is stored in the storage unit 520, and a general-purpose processing unit executes the code in the storage unit 520 to implement the functions of the processing unit 510, the input port 530, and the output port 540.

In an implementation, the processing unit 510 is configured to generate first indication information. The first indication information instructs a terminal device to enter a time synchronization activated state of a first clock source, or the first indication information instructs the terminal device to enter a time synchronization deactivated state of the first clock source. The first clock source includes a clock source of an external system.

The output port 540 is configured to send the first indication information.

Optionally, the input port 530 is configured to receive second indication information. The second indication information requests to activate time synchronization of the first clock source of the terminal device, or the second indication information requests to deactivate time synchronization of the first clock source of the terminal device.

When the second indication information requests to activate time synchronization of the first clock source of the terminal device, the processing unit is further configured to establish a first QoS flow based on the second indication information. The first QoS flow is for the first terminal device to transmit the time synchronization packet of the first clock source.

When the second indication information requests to deactivate time synchronization of the first clock source of the terminal device, the processing unit is further configured to tear down the first QoS flow based on the second indication information.

Functions and actions of the modules or units in the apparatus 500 enumerated above are merely examples for description. When the apparatus 500 is configured on or is a network device, the modules or units in the apparatus 500 may be configured to perform actions or processing processes performed by the network device (for example, the network device #1, the network device #A, or the network device #X) in the foregoing method. To avoid repetition, detailed descriptions are omitted herein.

For concepts, explanations, detailed descriptions, and other steps of the apparatus 500 that are related to the technical solutions provided in this embodiment of this disclosure, refer to descriptions about the content in the foregoing method or other embodiments. Details are not described herein again.

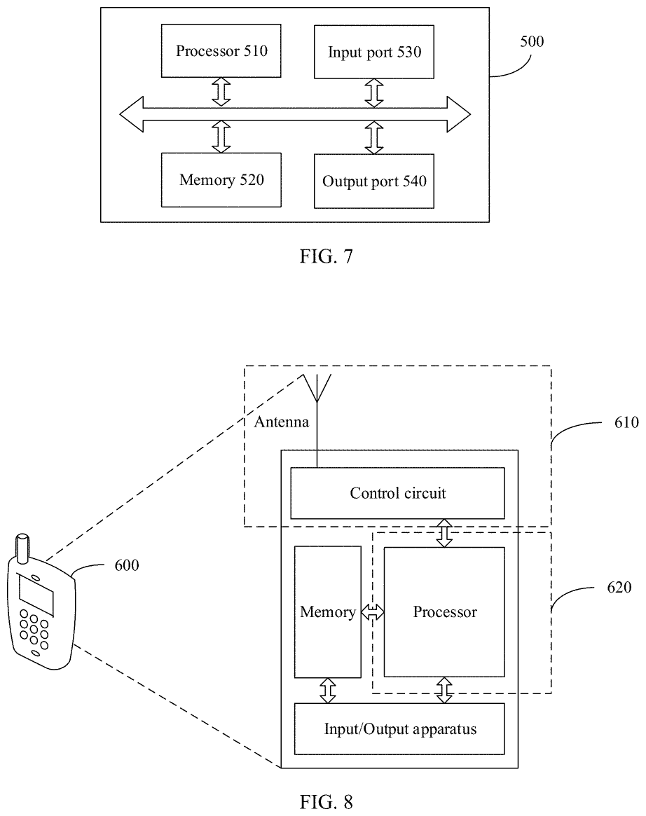

FIG. 8 is a schematic diagram of a structure of a terminal device 600 according to this disclosure. The apparatus 400 may be configured in the terminal device 600, or the apparatus 400 may be the terminal device 600. In other words, the terminal device 600 may perform an action performed by the terminal device (for example, the terminal device #1, the terminal device #A, or the terminal device #X) in the foregoing method.

For ease of description, FIG. 8 shows only main components of the terminal device. As shown in FIG. 8, the terminal device 600 includes a processor, a memory, a control circuit, an antenna, and an input/output apparatus.

The processor is mainly configured to process a communications protocol and communication data, control the entire terminal device, execute a software program, and process data of the software program, for example, configured to support the terminal device in performing actions described in the foregoing embodiment of the transmission precoding matrix indication method. The memory is mainly configured to: store the software program and the data, for example, store a codebook described in the foregoing embodiment. The control circuit is mainly configured to convert a baseband signal and a radio frequency signal and process the radio frequency signal. The control circuit and the antenna together may also be referred to as a transceiver, and are mainly configured to receive and send a radio frequency signal in a form of an electromagnetic wave. The input/output apparatus, such as a touchscreen, a display, or a keyboard, is mainly configured to: receive data input by a user and output data to the user.

After the terminal device is powered on, the processor may read the software program in the storage unit, interpret and execute instructions of the software program, and process data of the software program. When data needs to be sent wirelessly, the processor performs baseband processing on the to-be-sent data, and then outputs a baseband signal to a radio frequency circuit. The radio frequency circuit performs radio frequency processing on the baseband signal, and then sends, by using the antenna, a radio frequency signal in an electromagnetic wave form. When data is sent to the terminal device, the radio frequency circuit receives the radio frequency signal through the antenna, converts the radio frequency signal into a baseband signal, and outputs the baseband signal to the processor. The processor converts the baseband signal into data, and processes the data.

A person skilled in the art may understand that for ease of description, FIG. 8 shows only one memory and one processor. In an actual terminal device, there may be a plurality of processors and memories. The memory may also be referred to as a storage medium, a storage device, or the like. This is not limited in embodiments of this disclosure.

For example, the processor may include a baseband processor and a central processing unit. The baseband processor is mainly configured to process the communications protocol and the communication data. The central processing unit is mainly configured to: control the entire terminal device, execute the software program, and process the data of the software program. The processor in FIG. 8 integrates functions of the baseband processor and the central processing unit. A person skilled in the art may understand that the baseband processor and the central processing unit may alternatively be independent processors, and are interconnected by using a technology such as a bus. A person skilled in the art may understand that the terminal device may include a plurality of baseband processors to adapt to different network standards, and the terminal device may include a plurality of central processing units to enhance processing capabilities of the terminal device, and components of the terminal device may be connected by using various buses. The baseband processor may also be expressed as a baseband processing circuit or a baseband processing chip. The central processing unit may alternatively be expressed as a central processing circuit or a central processing chip. A function of processing the communications protocol and the communication data may be built in the processor, or may be stored in the storage unit in a form of a software program, and the processor executes the software program to implement a baseband processing function.

For example, in this embodiment of this disclosure, the antenna that has receiving and transmitting functions and the control circuit may be considered as a transceiver unit 610 of the terminal device 600, and the processor that has a processing function may be considered as a processing unit 620 of the terminal device 600. As shown in FIG. 8, the terminal device 600 includes the transceiver unit 610 and the processing unit 620. The transceiver unit may also be referred to as a transceiver, a transceiver device, a transceiver apparatus, or the like. Optionally, a component that is in the transceiver unit 610 and that is configured to implement a receiving function may be considered as a receiving unit, and a component that is in the transceiver unit 610 and that is configured to implement a sending function may be considered as a sending unit. In other words, the transceiver unit includes the receiving unit and the sending unit. For example, the receiving unit may also be referred to as a receiving device, a receiver, a receiving circuit. The sending unit may be referred to as a transmitting device, a transmitter, a transmitting circuit, or the like.

According to the method provided in embodiments of this disclosure, an embodiment of this disclosure further provides a communications system, including one or more of the foregoing terminal devices and network devices.

It should be understood that, the processor in embodiments of this disclosure may be a central processing unit (CPU), or may be another general purpose processor, a digital signal processor (DSP), an disclosure-specific integrated circuit (ASIC), a field programmable gate array (FPGA), or another programmable logic device, discrete gate or transistor logic device, discrete hardware component, or the like. The general-purpose processor may be a microprocessor, or the processor may be any conventional processor or the like.

It may be understood that the memory in embodiments of this disclosure may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. Through an example rather than a limitative description, random access memories (RAM) in many forms may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

All or a part of the foregoing embodiments may be implemented using software, hardware, firmware, or any combination thereof. When the software is used to implement the embodiments, all or a part of the foregoing embodiments may be implemented in a form of a computer program product. The computer program product includes one or more computer instructions or computer programs. When the program instructions or the computer programs are loaded and executed on the computer, the procedure or functions according to embodiments of this disclosure are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, and microwave, or the like) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

It should be understood that the term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

It should be understood that sequence numbers of the foregoing processes do not mean execution sequences in various embodiments of this disclosure. The execution sequences of the processes should be determined according to functions and internal logic of the processes, and should not be construed as any limitation on the implementation processes of embodiments of this disclosure.

A person of ordinary skill in the art may be aware that, in combination with the examples described in embodiments disclosed in this specification, units and algorithm steps may be implemented by electronic hardware or a combination of computer software and electronic hardware. Whether the functions are performed by using hardware or software depends on particular disclosures and design constraints of the technical solutions. A person skilled in the art may use different methods to implement the described functions for each particular disclosure, but it should not be considered that the implementation goes beyond the scope of this disclosure. It may be clearly understood by a person skilled in the art that, for the purpose of convenient and brief description, for a detailed working process of the foregoing system, apparatus, and unit, refer to a corresponding process in the foregoing method embodiments, and details are not described herein again. In the several embodiments provided in this disclosure, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or a part of the units may be selected based on actual requirements to achieve the objectives of the solutions of embodiments. In addition, function units in embodiments of this disclosure may be integrated into one processing unit, or each of the units may exist alone physically, or two or more units may be integrated into one unit. When the functions are implemented in the form of a software function unit and sold or used as an independent product, the functions may be stored in a computer-readable storage medium. Based on such an understanding, the technical solutions of this disclosure essentially, or the part contributing to the conventional technology, or some of the technical solutions may be implemented in a form of a software product. The software product is stored in a storage medium, and includes several instructions for instructing a computer device (which may be a personal computer, a server, or a network device) to perform all or a part of the steps of the methods described in embodiments of this disclosure. The foregoing storage medium includes any medium that can store program code, such as a USB flash drive, a removable hard disk, a read-only memory, a random access memory, a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A method for processing a time synchronization packet, comprising:
receiving, by a terminal device, a time synchronization packet of a first clock source from an external device;
receiving first indication information from a network device, wherein the first indication information instructs the terminal device to enter a time synchronization activated state of the first clock source, or the first indication information instructs the terminal device to enter a time synchronization deactivated state of the first clock source; and
processing the time synchronization packet of the first clock source based on the first indication information.

2. The method according to claim 1, wherein when the first indication information instructs the terminal device to enter the activated state,
processing the time synchronization packet of the first clock source based on the first indication information comprises:
updating, based on the first indication information, information carried in the time synchronization packet of the first clock source, and forwarding the time synchronization packet of the first clock source to a user plane function (UPF) entity; or
initiating establishment of a first quality of service flow (QoS flow) based on the first indication information, wherein the first QoS flow is used for transmitting the time synchronization packet of the first clock source.

3. The method according to claim 1, wherein when the first indication information instructs the terminal device to enter the deactivated state,
processing the time synchronization packet of the first clock source based on the first indication information comprises:
discarding the time synchronization packet of the first clock source based on the first indication information;
transparently transmitting the time synchronization packet of the first clock source to the UPF based on the first indication information; or
tearing down the first QoS flow based on the first indication information, wherein the first QoS flow is used for transmitting the time synchronization packet of the first clock source.

4. The method according to claim 1, wherein the first indication information comprises an identifier of the terminal device, an identifier of the first clock source, and a first identifier, and the first identifier indicates the activated state or the deactivated state.

5. The method according to claim 4, wherein the first indication information comprises a port number of a first port, and the first port comprises a port configured to transmit the time synchronization packet of the first clock source; and/or
the first indication information comprises an identifier of a first application service entity configured to provide a first service for the terminal device, and the first service is based on time synchronization of the first clock source.

6. The method according to claim 1, wherein the first clock source comprises a latency sensitive network (TSN) clock source.

7. The method according to claim 1, wherein
the time synchronization packet of the first clock source comprises a generic precision time protocol (gPTP) packet; or
the time synchronization packet of the first clock source comprises a precision time protocol (PTP) packet.

8. The method according to claim 1, further comprising:
if the first indication information indicates to enter the activated state, keeping time synchronization of the first clock source; or
if the first indication information indicates to enter the deactivated state, stopping time synchronization of the first clock source.

9. A method for processing a time synchronization packet, comprising:
generating, by a network device, first indication information, wherein the first indication information instructs a terminal device to enter a time synchronization activated state of a first clock source, or the first indication information instructs the terminal device to enter a time synchronization deactivated state of the first clock source, and the first clock source comprises a clock source of an external system; and
sending the first indication information.

10. The method according to claim 9, wherein the first indication information comprises an identifier of the terminal device, an identifier of the first clock source, and a first identifier, and the first identifier indicates the activated state or the deactivated state.

11. The method according to claim 10, wherein the first indication information comprises a port number of a first port, and the first port comprises a port configured to transmit a time synchronization packet of the first clock source; and/or
the first indication information comprises an identifier of a first application service entity configured to provide a first service for the terminal device, and the first service is based on time synchronization of the first clock source.

12. The method according to claim 9, wherein when the first indication information indicates to enter the activated state,
the first indication information instructs the terminal device to update information carried in the time synchronization packet of the first clock source, and forward the time synchronization packet of the first clock source to a user plane function (UPF) entity; or
the first indication information instructs the terminal device to initiate establishment of a first quality of service flow (QoS flow), wherein the first QoS flow is used for transmitting the time synchronization packet of the first clock source.

13. The method according to claim 9, wherein when the first indication information indicates to enter the deactivated state,
the first indication information instructs the terminal device to discard the time synchronization packet of the first clock source;
the first indication information instructs the terminal device to transparently transmit the time synchronization packet of the first clock source to the UPF; or
the first indication information instructs the terminal device to tear down the first QoS flow, wherein the first QoS flow is used for transmitting the time synchronization packet of the first clock source.

14. The method according to claim 13, wherein the first clock source comprises a latency sensitive network (TSN) clock source.

15. The method according to claim 9, wherein
the time synchronization packet of the first clock source comprises a generic precision time protocol (gPTP) packet; or
the time synchronization packet of the first clock source comprises a precision time protocol (PTP) packet.

16. The method according to claim 9, further comprising:
receiving second indication information, wherein the second indication information requests to activate time synchronization of the first clock source of the terminal device, or the second indication information requests to deactivate time synchronization of the first clock source of the terminal device; and
processing the first QoS flow based on the second indication information, wherein the first QoS flow is for the first terminal device to transmit the time synchronization packet of the first clock source.

17. The method according to claim 16, wherein the processing the first QoS flow based on the second indication information comprises:
processing the first QoS flow based on the second indication information and a status of the first clock source in the first terminal device.

18. The method according to claim 17, wherein the processing the first QoS flow based on the second indication information and a status of the first clock source in the first terminal device comprises:
if the second indication information is first information that is received by the network device and that requests to activate time synchronization of the first clock source of the terminal device, establishing the first QoS flow for the first terminal device to transmit the time synchronization packet of the first clock source; or
if the second indication information requests to deactivate time synchronization of the first clock source of the terminal device, and an application service (AF) entity that sends the second indication information is a last AF that provides a service for the terminal device based on the first clock source, tearing down the first QoS flow.

19. The method according to claim 16, wherein the second indication information comprises the identifier of the terminal device, the identifier of the first clock source, and a second identifier, and the second identifier indicates the activation or the deactivation.

20. The method according to claim 19, wherein the second indication information is sent by the first application service entity; and
the second indication information comprises an identifier of the first application service entity.
